(19) United States
(12) Patent Application Publication
(10) Pub. No.: US 2026/0212443 A1
(43) Pub. Date: Jul. 23, 2026

(54) METHOD AND COMPUTER DEVICE FOR TRANSFORMING A TEXTURED MESH OF A DESIGNED OBJECT INTO A TEXTURED MESH OF A MANUFACTURED OBJECT CORRESPONDING TO SAID DESIGNED OBJECT

(71) Applicants: Airbus SAS, BLAGNAC (FR); Airbus Operations SAS, TOULOUSE (FR); Airbus Operations GmbH, HAMBURG (DE)

(72) Inventors: Matthias OTTO, HAMBURG (DE); Fabian MAHLER, HAMBURG (DE); Boris MORINIERE, ROCHEFORT (FR); Olivier BÜRGY, TOULOUSE (FR); Samuel LELEU, TOULOUSE (FR)

(21) Appl. No.: 19/451,401

(22) Filed: Jan. 16, 2026

(30) Foreign Application Priority Data
Jan. 20, 2025 (FR) FR2500560

(51) Int. Cl. G06T 3/147; G06T 17/20

(52) U.S. Cl. CPC G06T 3/147; G06T 17/20

(57) ABSTRACT

A method for determining a transformed textured mesh of a three-dimensional manufactured object on the basis of an initial textured mesh of a three-dimensional designed object, the transformed textured mesh to be used when printing a corresponding two-dimensional texture on the manufactured object by iteratively determining a set of affine transformations with individualized parameters to minimize the value of a target function having at least one term promoting a specific property, the set of affine transformations thus determined being applied to the vertices of the initial textured mesh so as to obtain the transformed textured mesh.

### CROSS-REFERENCE TO RELATED APPLICATIONS

This application claims the benefit of French Patent Application No. FR2500560, filed on Jan. 20, 2025, the entire disclosure of which is incorporated herein by way of reference.

### FIELD OF THE INVENTION

The present invention relates to a method and a computer device for transforming a textured mesh of a designed object into a textured mesh of a manufactured object corresponding to said designed object.

### BACKGROUND OF THE INVENTION

The invention relates more particularly to the field of texture mapping, which consists in applying data from a two-dimensional texture to a three-dimensional object. Texture mapping may be used to print representations of colors, of text, of logos, of images, of artistic drawings etc. on the three-dimensional object. This three-dimensional object may be large, such as an airplane, for example, and have one or more curved surfaces. With a view to manufacturing a three-dimensional object, a three-dimensional object with which a two-dimensional texture is associated is generally designed beforehand via computer-aided design.

However, in general, the geometry of the manufactured object does not correspond perfectly to that of the initially designed object, often with errors which are significantly greater than the required printing precision. For example, in the context of printing on an airplane, the airplane as manufactured generally has a shape which is different from that of the designed airplane, because of distortions which are notably due to a different distribution of the forces between an airplane in flight and an airplane on the ground, as well as with respect to manufacturing tolerances. It is necessary to take account of such distortions in texture mapping.

The existence of a mapping method based on matching a tessellated mesh of the manufactured object with a tessellated mesh of the designed object in order to transfer the coordinates of the texture of the livery is known from the prior art. The tessellated mesh of the manufactured object is constructed on the basis of a (noisy) cloud of points acquired via metrology. The result is a complex tessellation and a large mesh potentially containing several times as many vertices as the mesh of the designed object, which makes it necessary (in order to obtain a mesh small enough to be used subsequently in the computation of raster images) to put in place filtering which is both complex (intensive computation, adjustments which are difficult to carry out, compromise to be found between fidelity to the manufactured object and the number of vertices etc.) and difficult to implement.

In addition, implementing a rigid transformation (that is to say the same transformation which applies to all transformed points) for alignment with the cloud of points is known from the art, which may generate problems with the fidelity of the reproduction of the texture on the manufactured object with respect to the designed object, since during manufacture not all the points undergo the same distortion between the designed object and the manufactured object.

There is therefore a need to find a solution which makes it possible to determine, with precision, on the basis of a textured mesh of the designed object on the basis of which a manufactured object is manufactured, a textured mesh of the manufactured object, which makes it possible to faithfully reproduce the texture.

### SUMMARY OF THE INVENTION

An object of the present invention is to propose such a solution. For this purpose, it relates to a method for determining a textured mesh referred to as a transformed textured mesh of a three-dimensional manufactured object on the basis of a textured mesh referred to as an initial textured mesh of a three-dimensional designed object, the manufactured object corresponding to the designed object, said transformed textured mesh being intended to be used when printing a corresponding two-dimensional texture on the manufactured object, said method being implemented by a computer device and comprising at least the following steps:
a reception step for receiving a mesh representing the three-dimensional designed object and an associated two-dimensional texture, which form said initial textured mesh comprising vertices, as well as three-dimensional points from a cloud of points acquired on the manufactured object; and
a determination step for determining the transformed textured mesh, taking into account at least some of said vertices and at least some of said three-dimensional points.

According to the invention, the determination step implements iterative processing (or computation) in order to determine a set of affine transformations with individualized parameters making it possible to minimize the value of a target function, taking account of said initial textured mesh and of said three-dimensional points taken into account from the cloud of points, the target function (specified below) comprising at least one term promoting a specific property relating to the set of affine transformations, the set of affine transformations thus determined being applied to the vertices taken into account of the initial textured mesh so as to obtain said transformed textured mesh.

In the context of the present invention, what is meant by “set of affine transformations with individualized parameters” is the fact that the different parameters of the set of transformations are determined individually, and in particular are not, on principle, all equal as in the case of a rigid transformation. This set of affine transformations with individualized parameters therefore makes it possible to implement a non-rigid transformation.

In a preferred embodiment, the determination step comprises at least the sequence of following successive substeps, said sequence being implemented iteratively:
a first substep for applying a set of affine transformations to the vertices taken into account of the initial textured mesh so as to obtain vertices of a textured mesh referred to as a computed textured mesh, said set of affine transformations corresponding, during the first iteration, to a predetermined set of affine transformations and, during each of the following iterations, to a set of affine transformations which is determined in the preceding iteration;
a second substep for computing the value of the target function on the basis of the vertices taken into account of the initial textured mesh, of the three-dimensional points taken into account from the cloud of points and of the vertices of the computed textured mesh;
a third substep for comparing said computed value of the target function with a predetermined threshold value and for:
   if said computed value is less than the threshold value, stopping the determination step and considering that the transformed textured mesh corresponds to the textured mesh computed in the first substep of the current iteration; and
   if said computed value is greater than or equal to the threshold value, continuing the determination step by implementing the fourth substep; and
the fourth substep for determining a new set of affine transformations depending on the target function and on the set of affine transformations, this new set of affine transformations being used in the first substep of the following iteration.

Thus, by virtue of the invention, two meshes of similar type (with the same number of vertices) are provided, the first mesh corresponding to the tessellation of the object as designed and the second mesh being created as a copy of the first mesh, which copy is formed to adapt to the object as manufactured (defined by the cloud of points acquired) using a non-rigid transformation, that is to say a potentially different (affine) transformation for each vertex of the mesh.

For this purpose, the method uses a distortion model (namely said set of affine transformations) modeling the non-rigid distortion (due, for example, to gravity and to manufacturing tolerances in the case of an airplane) of the manufactured object compared to the object as drawn (or designed) in CAD (computer-aided design). This causes a slight displacement of the vertices of the created mesh without changing the overall structure of the mesh (same number of vertices and of polygons, regularity of the polygons etc.). The method thus makes it possible to determine, relatively simply (without complex filtering) and precisely, a textured mesh of a manufactured object which makes it possible to carry out a reproduction taking into account particular characteristics of the fuselage (windows, door frames etc.).

In addition, the method carries out a non-rigid transformation of the second mesh in order to adjust the cloud of points of the manufactured object using the set of transformations, which may be adapted in order to ensure, notably, as specified below, that certain vertices correspond precisely to desired positions and that the proportion of certain parts of the texture is maintained.

Consequently, by virtue of the invention, it is not necessary to proceed with a complex tessellation on the basis of a cloud of noisy points and with an associated complex filtering, as in the aforementioned example of the document U.S. Pat. No. 10,198,860 B1.

Advantageously, said determination step is stopped, if necessary, when a predetermined number of iterations is reached, the transformed textured mesh then corresponding to the last computed textured mesh.

In the context of the present invention, the target function comprises at least one term and preferably a plurality of terms, specified below, which promote, each time, a specific property relating to the set of transformations.

Thus, advantageously, the target function comprises at least one term causing certain vertices of the transformed textured mesh to correspond (precisely) to points referred to as target points of the manufactured object.

Moreover, advantageously, the target function comprises at least one term causing certain vertices of the transformed textured mesh to maintain a predetermined distance between them so as to maintain the proportions of certain parts of the livery.

Furthermore, in one particular embodiment, the target function comprises at least one of the following terms:
a term causing the transformed textured mesh to adapt to the three-dimensional points acquired on the manufactured object;
a term causing the transformation generated by the set of affine transformations to force a smooth distortion;
a term causing the transformation generated by the set of affine transformations to approach a rigid transformation.

In a preferred embodiment, the fourth substep comprises the following successive operations:
computing the gradient of the target function with respect to the set of affine transformations;
determining a direction of adjustment on the basis of this gradient; and
determining a new set of affine transformations along this direction of adjustment.

Advantageously, the fourth substep uses a specialized non-linear least squares solver.

In one particular embodiment, the method comprises:
a computing step for determining the initial set of affine transformations; and/or
a computing step for determining the target points of the manufactured object; and/or
a computing step for determining at least one zone of the two-dimensional texture the proportions of which must be preserved.

The present invention also relates to a computer device for determining a textured mesh referred to as a transformed textured mesh of a three-dimensional manufactured object on the basis of a textured mesh referred to as an initial textured mesh of a three-dimensional designed object, the manufactured object corresponding to the designed object, said transformed textured mesh being intended to be used when printing a corresponding two-dimensional texture on the manufactured object, said computer device comprising at least:
a reception unit configured to receive a mesh representing the three-dimensional designed object and the associated two-dimensional texture, which form said initial textured mesh comprising vertices, as well as three-dimensional points from a cloud of points acquired on the manufactured object; and
a computing unit configured to determine the transformed textured mesh, taking into account at least some of said vertices and at least some of said three-dimensional points.

According to the invention, the computing unit comprises computing elements configured to implement iterative processing (or computation) in order to determine a set of affine transformations with individualized parameters making it possible to minimize the value of a target function, taking account of said initial textured mesh and of said three-dimensional points taken into account from the cloud of points, the target function comprising at least one term promoting a specific property relating to the set of affine transformations, the set of affine transformations which is thus determined being applied to the vertices taken into account of the initial textured mesh so as to obtain said transformed textured mesh.

### BRIEF DESCRIPTION OF THE DRAWINGS

The appended figures will make it easy to understand how the invention may be implemented. In these figures, identical references denote similar elements.

FIG. 1 is the block diagram of a method for transforming a textured mesh of a designed object into a textured mesh of a manufactured object corresponding to said designed object.

FIG. 2 schematically shows a device configured to implement the method of FIG. 1.

FIG. 3 schematically shows part of a designed object and the same part of a manufactured object, making it possible to clearly highlight features of the method of FIG. 1.

### DESCRIPTION OF THE PREFERRED EMBODIMENTS

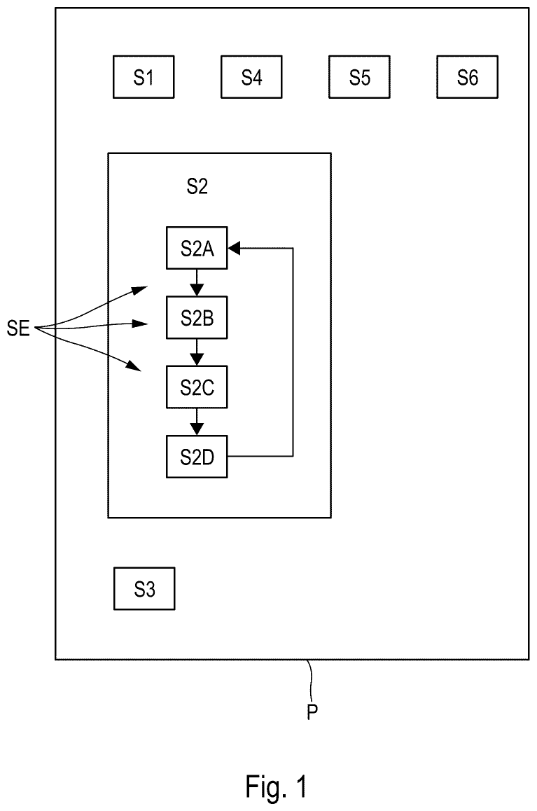

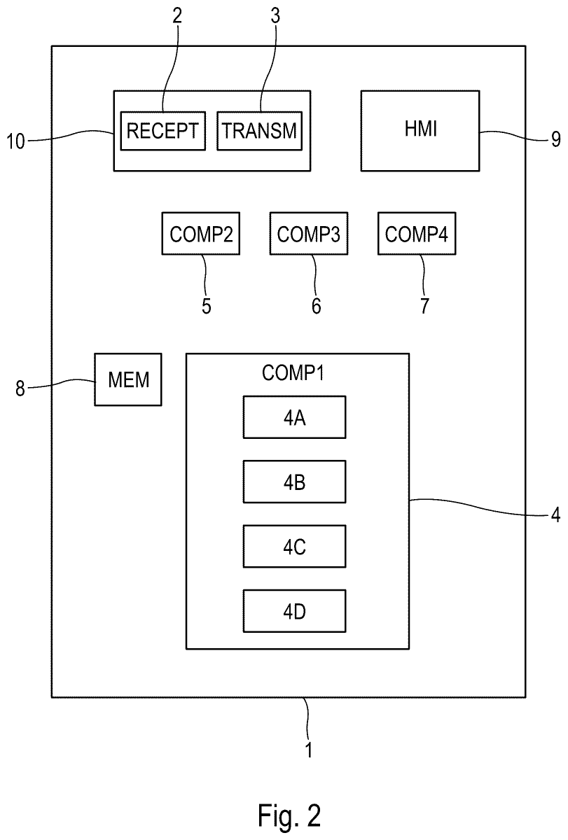

In the context of the present invention, a method P (for example, such as that depicted in one particular embodiment in FIG. 1), which is capable of being implemented by a computer device 1 (for example, such as that depicted in one particular embodiment in FIG. 2), is intended to form a textured mesh specified below.

This textured mesh is used in texture mapping, which consists in applying data from a two-dimensional (or 2D) texture to a three-dimensional (or 3D) object. Texture mapping may be used to add representations notably of colors, of text, of logos, of images, of artistic drawings etc. to the three-dimensional object.

The textured mesh obtained is notably used by a conventional printing system (not depicted) for direct-to-shape (DTS) printing, which is a printing technology which makes it possible to print directly on the three-dimensional surface of an object, whatever its shape or its texture. This textured mesh notably makes it possible to determine raster images which are capable of being used by the printing system.

In the context of the present invention, for reasons of simplification, what is meant by “object” is any machine or other mechanical element or part of such a machine or other mechanical element, a surface or part of a surface of which is capable of receiving such printing. It may notably be an external surface of an airplane on which characteristic signs (logos, colors etc.) and technical markings (identifiers of the doors and panels, instructions for ground personnel etc.) of the airline which will operate the airplane will be printed.

With a view to manufacturing a three-dimensional object, a three-dimensional object with which a two-dimensional texture defining the representation to be applied to the designed object is associated is generally designed beforehand via computer-aided design.

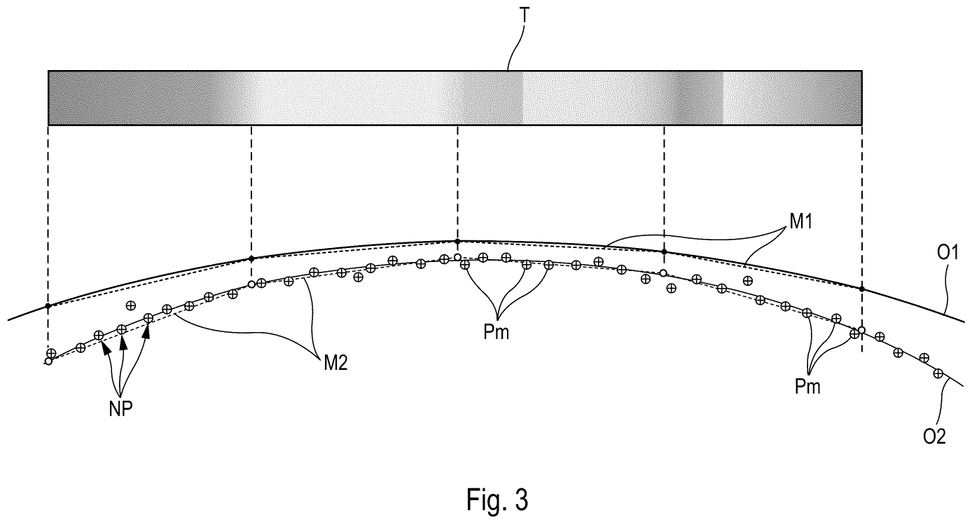

FIG. 3 depicts, by way of illustration, a two-dimensional texture T which is defined for the designed object O1 depicted (partially) in section and which is intended to be applied to a manufactured object O2 also depicted (partially) in section.

The manufactured object O2 corresponds to the designed object O1, that is to say that it is manufactured on the basis of the designed object O1. Now, generally, the geometry of the manufactured object O2 does not correspond perfectly to that of the initially designed object O1, as shown in FIG. 2, often with errors significantly greater than the required printing precision, which may be less than one millimeter or even drop to a few tens of microns. For example, in the case of an airplane, the manufactured airplane generally has a shape which is different from that of the designed airplane, because of distortions which are notably due to gravity (up to a few centimeters) and manufacturing tolerances (up to a few millimeters).

The manufactured object O2 is defined by a cloud of points NP, as depicted in FIG. 3. The three-dimensional points Pm from this cloud of points NP are usually determined (or measured or acquired) by a metrology system, for example by photogrammetry (which uses photographs), using a laser scanner or by profilometry (which measures the topography of the surface). In the case of a large three-dimensional object, such as part of the fuselage of an airplane, for example, the number of three-dimensional points may be very high, of the order of a million or even a billion points.

The object of the method P implemented by the computer device 1 is to determine a textured mesh referred to as a transformed textured mesh M2 of the manufactured object O2, on the basis of a textured mesh referred to as an initial textured mesh M1 of the designed object O1.

The transformed textured mesh M2 is intended for printing the corresponding two-dimensional texture T on the manufactured object O2, notably by being used to form raster images.

For this purpose, said method P notably comprises, as depicted in FIG. 1, the following steps, implemented by the computer device 1:
a reception step S1 implemented by a reception unit 2 (RECEPT) of the computer device 1 (FIG. 2), for receiving at least:
a tessellated mesh representing the three-dimensional designed object O1 and an associated two-dimensional texture T, which form the initial textured mesh M1 comprising N vertices; and
M three-dimensional points Pm from a cloud of points NP acquired on the manufactured object O2, M being an integer which is different from the integer N and generally greater than N; and
a determination step S2 implemented by a computing unit 4 (COMP1) of the computer device 1, for determining the transformed textured mesh M2, at least on the basis of the following elements: at least some or all of the N vertices and at least some or all of the M three-dimensional points; and
a transmission step S3 implemented by a transmission unit 3 (TRANSM) of the computer device 1, for transmitting the transformed textured mesh M2 to a user device (not depicted), for example a computer, and notably a computer for determining raster images which are capable of being used by the printing system.

In the remainder of the description, the following parameters are taken into account:
X={x₀, . . . , x_{N-1}}, which are the N vertices of the textured mesh M1 of the designed object O1;
Y={y₀, . . . , y_{M-1}}, which are the M three-dimensional points (referenced Pm in FIG. 3) from the cloud of points NP, as acquired on the manufactured object O2; and
\hat{X}={\hat{x}₀, . . . , \hat{x}_{N-1}}, which are the respective positions of the N points of the transformed textured mesh M2, which is determined in the determination step S2 of the method P.

In the determination step S2, it is possible to use all the N vertices and all the M three-dimensional points, but it is also possible to select only some of these N vertices and/or some of these M three-dimensional points according to the desired position. The selection is important with respect to the points, since there is a desire to avoid a shift with respect to the theoretical position which was determined in CAD.

In the following description, all the N vertices and all the M three-dimensional points are taken into account and used in the determination step.

As depicted in FIG. 1, the determination step S2 comprises a sequence SE of successive substeps S2A to S2D. This suite SE is implemented iteratively.

The determination step S2 comprises, first of all, the substep S2A implemented by a computing element 4A of the computing unit 4, for applying a set of affine transformations Ξ=((A₀, t₀), . . . , (A_{N-1}, t_{N-1})) to the N vertices of the initial textured mesh M1 so as to obtain N vertices of a textured mesh referred to as a computed textured mesh M3. The set of affine transformations corresponds:
during the first iteration, to a set of affine transformations referred to as an initial set of affine transformations; this initial set of affine transformations may be, for example, as simple as a set of rigid transformations where the rigid transformations are all the same and correspond to the best adjustment of the vertices on the clouds of points; and
during each of the following iterations, to the set of affine transformations determined at the (directly) previous iteration.

To compute a non-rigid transformation, the method P uses a potentially different affine transformation (Aᵢ, tᵢ) at each point xᵢ of the textured mesh M1, which is written as follows:

\hat{x}ᵢ=Aᵢxᵢ+tᵢ with Aᵢ∈R^{3×3} and tᵢ∈R³, (Aᵢ, tᵢ) being an affine transformation, the twelve components of Aᵢ and tᵢ have no a priori constraints (unlike a rigid transformation, where Aᵢ would be a matrix of rotation).

The set of transformations is thus referred to as “a set of transformations with individualized parameters”.

The determination step S2 then comprises the substep S2B implemented by a computing element 4B of the computing unit 4, for computing the value V1 of a target function E on the basis of the N vertices of the initial textured mesh M1, of the M three-dimensional points from the cloud of points NP and of the N vertices of the computed textured mesh M3 (computed in the substep S2A). The target function E comprises at least one term promoting a specific property relating to the set of affine transformations, as specified below.

The determination step S2 then comprises the substep S2C implemented by a computing element 4C of the computing unit 4, for comparing the computed value V1 (computed in the substep S2B) of the target function E with a predetermined threshold value V2 of this target function E and for:
if the computed value V1 is less than the threshold value V2, stopping the determination step S2 and considering that the transformed textured mesh M2 corresponds to the textured mesh M3 computed in the substep S2A of the current iteration; and
if the computed value V1 is greater than or equal to the threshold value V2, continuing the determination step S2 by implementing the substep S2D.

The substep S2D is implemented by a computing element 4D of the computing unit 4, in order to determine a new set of affine transformations depending on the target function E and on the current set of affine transformations, this new set of affine transformations being used in the substep S2A of the following iteration.

The determination step S2 therefore carries out an optimization operation, the objective of which is to find the (individualized) parameters of the set of affine transformations which minimize the target function E.

Moreover, in one particular embodiment, the determination step S2 is also stopped when a predetermined number of iterations is reached, even if the computed value V1 is not (yet) less than the threshold value V2.

In this case, the transformed textured mesh M2 corresponds to the last computed textured mesh M3 obtained in the substep S2A.

In this particular embodiment, the sequence SE of successive substeps is therefore implemented iteratively until one of the following conditions is met: a predetermined number of iterations is reached, the computed value V1 of the target function E is less than the threshold value V2.

Moreover, in one particular embodiment, the method P also comprises a computing step S4 implemented by a computing element 5 (COMP2) of the computer device 1, for determining the initial affine transformation (used during the first iteration in the substep S2A). It is not a single affine transformation, but a set of affine transformations, even if, typically, the same transformation will be chosen for all the points, and this transformation will be a rigid transformation which will adjust best to the N vertices on the M points from the cloud of points.

In a first implementation of this particular embodiment, the computing step S4 determines the rigid transformation on the basis of an ICP (iterative closest point) algorithm, and uses it as the initial affine transformation for each point xᵢ of the textured mesh M1.

Furthermore, in a second implementation of this particular embodiment, the computing step S4 estimates the initial affine transformation on the basis of available data such as, for example, an approximate knowledge of the reference frame of the textured mesh of the designed object O1 in the reference frame of the metrology system used to scan the manufactured object O2.

As indicated above, the target function E used in the substep S2B comprises at least one term promoting a specific property, relating to the set of affine transformations.

Preferably, the target function E comprises a plurality of such terms, with which weighting coefficients are associated, as specified below, in order to weight the relative effect which is intended to be given to the different terms.

The target function E comprises at least one position term Eₚ causing certain vertices of the transformed textured mesh M2 to approach points referred to as target points of the manufactured object O2.

The purpose of this position term Eₚ is therefore to force certain points to be close to certain target points (or positions). This is particularly adapted to the situation where certain elements of the texture must be attached to specific points of the manufactured object O2, for example on the outline of a window or of a door in the case of an airplane, and no displacement of this representation is desired.

In this case, the method P preferably comprises a computing step S5, implemented by a computing element 6 (COMP3) of the computer device 1, for determining these target points. In this context, C designates a set of vertices X={x₀, . . . , x_{N-1}} with position constraints and mᵢ designates the specific target point from the cloud of points Y={y₀, . . . , y_{M-1}} which is determined in order to correspond to each point x¿ forming part of the set C.

In a preferred embodiment, the position term Eₚ satisfies the following expression:

$${E}_{p} = {\sum }_{{x}_{i} ∈ C} {‖ {\hat{x}}_{i} - {m}_{i} ‖}^{2}$$

in which:
   C is therefore a set of mesh points with position constraints; and
   mᵢ is therefore a specific target point for xᵢ. Typically, in the case of an airplane, it may therefore be points on the outline of the doors and windows, an outline where there is a desire for particular decorative elements to be correctly installed. For example, when making a safety marking around a hatch, the marking must absolutely be centered with respect to the hatch since there is a positioning constraint to be respected.

Moreover, the target function E comprises at least one term referred to as a shape preservation term Eᵢ which causes certain vertices of the transformed textured mesh M2 to maintain a predetermined distance between them.

This is particularly adapted to the situation where the livery contains certain content, the proportions of which must not be distorted, such as, for example, a logo.

In this case, the method P preferably comprises a computing step S6, implemented by a computing element 7 (COMP4) of the computer device 1, for determining one or more zones of the two-dimensional texture T the proportions of which must be maintained. γᵢ is defined as a positive scalar weight for each vertex xᵢ of X={x₀, . . . , x_{N-1}} where γᵢ takes a strictly positive value when vertex xᵢ is in a zone of the two-dimensional texture T the proportions of which must be maintained, and γᵢ is set at zero everywhere else.

The purpose of this shape preservation term Eᵢ is to preserve a local shape, that is to say to guarantee that the distance metric is preserved locally around certain particular points.

For this purpose, the shape preservation term Eᵢ penalizes the change in distance between these points and their neighboring points.

Also, in a preferred embodiment, the shape preservation term Eᵢ satisfies the following expression:

$${E}_{i} = {\sum }_{i = 0}^{N - 1} γ i {\sum }_{k ∈ N ( i )} {‖ {A}_{i} ( {x}_{k} - {x}_{i} ) - ( {\hat{x}}_{k} - {\hat{x}}_{i} ) ‖}^{2}$$

in which:
   the γᵢ are weights which make it possible to select the zone of the livery for which the proportions (for example, the logo of an airline) must be preserved; and
   the N(i) are the vertices which are neighbors of xᵢ.

The position term Eₚ and the shape preservation term Eᵢ make it possible to guarantee that certain particular points of the representation correspond to certain points of the manufactured object O2 and that the proportion of certain chosen elements of the (printed) representation is preserved.

Moreover, in one particular embodiment, the target function E also comprises at least one term referred to as an alignment term Eq causing the transformed textured mesh M2 to adapt to the three-dimensional points acquired on the manufactured object O2.

In a preferred embodiment, the alignment term Eₐ satisfies the following expression:

$${E}_{a} = {\sum }_{i = 0}^{N - 1} {ω}_{i} {( {n}_{ρ ( i )} ( {\hat{x}}_{i} - {y}_{ρ ( i )} ) )}^{2}$$

in which:
   the wᵢ are weights which may be used to control the influence of different points depending on the reliability of their correspondence;
   ρᵢ is the index of the corresponding point on the cloud of points, for the point xᵢ. The correspondence is identified by searching for the nearest point in the cloud of points Y. This nearest point is denoted y_{ρ(i)}; and
   n_{ρ(i)} is the unit normal of the target surface at the corresponding point y_{ρ(i)}.

This target surface is computed with a local regression of the neighbors of y_{ρ(i)}.

The term (n_{ρ(i)}(\hat{x}ᵢ−y_{ρ(i)})² then measures the square distance from \hat{x}ᵢ to the plane which is tangent to y_{ρ(i)}.

Furthermore, in one particular embodiment, the target function E also comprises at least one smoothing term Eₛ.

The purpose of the smoothing term Eₛ is to force the distortion field to be smooth enough to avoid unnatural distorted shapes. What is meant by “regularity” is that the affine transformations assigned to two points xᵢ which are close to one another will have parameters which are close to one another.

For this purpose, the smoothing term Eₛ penalizes the difference between the transformations on neighboring points N(i).

In a preferred embodiment, the smoothing term Eₛ satisfies the following expression:

$${E}_{s} = {\sum }_{i = 0}^{N - 1} {\sum }_{k ∈ N ( i )} {‖ {T}_{i} - {T}_{j} ‖}_{F}^{2}$$

in which:
   ∥·∥_{F} is the Frobenius norm; and
   Tᵢ is the 3×4 matrix which concatenates Aᵢ and tᵢ.

Moreover, in one particular embodiment, the target function E also comprises at least one rigidity term Eᵣ causing the transformations of the set of affine transformations to approach a rigid transformation.

More specifically, the purpose of this rigidity term Eᵣ is thus to impose, on each affine transformation, being close to a rigid transformation (comprising a rotation and a translation).

In a preferred embodiment, the rigidity term Eᵣ satisfies the following expression:

$${E}_{r} = {\sum }_{i = 0}^{N - 1} Rot ( {A}_{i} ) + {\sum }_{i = 0}^{N - 1} {( det ( {A}_{i} ) - 1 )}^{2}$$

In this expression, Rot(Aᵢ) is written as follows:

$$Rot ( {A}_{i} ) = {( {a}_{i , 1} \cdot {a}_{i , 2} )}^{2} + {( {a}_{i , 1} \cdot {a}_{i , 3} )}^{2} + {( {a}_{i , 2} \cdot {a}_{i , 3} )}^{2} + {( 1 - {a}_{i , 1} \cdot {a}_{i , 1} )}^{2} + {( 1 - {a}_{i , 2} \cdot {a}_{i , 2} )}^{2} + {( 1 - {a}_{i , 3} \cdot {a}_{i , 3} )}^{2}$$

In addition, Aᵢ=[a_{i,1}a_{i,2}a_{i,3}] with

$${A}_{i}^{T} . {A}_{i} \approx {I}_{3}$$

In a preferred embodiment, the target function E used in the substep S2B satisfies the following expression/;

$$E = {C}_{1} \cdot {E}_{a} + {C}_{2} \cdot {E}_{s} + {C}_{3} \cdot {E}_{r} + {C}_{4} \cdot {E}_{p} + {C}_{5} \cdot {E}_{i}$$

In this expression, C₁, C₂, C₃, C₄ and C₅ are weighting coefficients associated with the different terms of the target function E, which preferably satisfy the preceding expressions.

These weighting coefficients make it possible to regulate the importance given to each term. Preferably, the position term Eₚ and the shape preservation term Eᵢ are favored.

Moreover, in a preferred embodiment, in the substep S2D, the computing element 4D implements the following successive operations:
it computes a gradient of the target function E with respect to the set of affine transformations Ξ=((A₀, t₀), . . . , (A_{N-1}, t_{N-1}));
it determines a direction of adjustment on the basis of this gradient, that is to say the direction in which the parameters (Aᵢ, tᵢ) of the set of affine transformations should be adjusted in order to reduce the value of the target function E; and
it determines a new set of affine transformations along this direction of adjustment, for example by adding a predetermined (or not predetermined) value to all the parameters (Aᵢ, tᵢ) of the set of affine transformations.

In one particular embodiment, in the substep S2D, the computing element 4D uses a specialized non-linear least squares (NLLS) solver, such as a Gauss-Newton or Levenberg-Marquardt solver. As the target function E has a sum of squares form, the convergence and optimization problem may be solved advantageously using such a solver to reach a super-linear convergence rate.

Moreover, the computer device 1 may also comprise, as depicted in FIG. 2:
at least one memory 8 (MEM) which is capable of storing data which are used for the data processing and computations implemented by the computing elements of the computer device 1, such as, for example, the initial set of transformations; and
a human-machine interface 9 (HMI) which makes it possible for an operator to supply data to the computer device 1, such as, for example, the threshold value V2 for the target function E.

In addition, the reception unit 2 and the transmission unit 3 may form part of a usual communication system 10 which makes it possible for the computer device 1 to communicate with devices which are external to said computer device 1, via a wired or non-wired link.

The different computing elements and/or computing units of the computer device 1 may correspond to any type of processor which is able to implement the corresponding processing and computations. They may be grouped in a single computing unit.

Consequently, in the context of the present invention, two meshes of similar type (with the same number of vertices and of polygons) are provided, the first mesh corresponding to the tessellation of the object as designed and the second mesh being created as a copy of the first mesh, which is designed to adapt to the manufactured object (defined by the cloud of points acquired).

The method P therefore implements (by means of the computer device 1) a non-rigid transformation which aligns the initial textured mesh with the three-dimensional points of the cloud of points acquired on the manufactured object, using a distortion model (or set of transformations) which models the distortion of the manufactured object with respect to the designed object. This causes a slight displacement of the vertices of the created mesh (the transformed textured mesh) without changing the overall structure of the mesh (same number of vertices and of polygons, regularity of the polygons etc.). Thus, unlike a rigid distortion, where the whole of the mesh undergoes the same transformation in order to align with the cloud of points, in the present non-rigid transformation, different parts of the mesh may undergo different distortions in order to take account of non-rigid behavior, as in the case of an airplane which may undergo an inhomogeneous overall distortion induced by gravity and/or a variation in sizing which is due to manufacturing tolerances.

The method P and the computer device 1, as described above, thus have many advantages. In particular, they make it possible:
to relatively simply (without complex filtering) determine the transformed textured mesh which, in addition, is particularly well adapted to simulating printing;
to help obtain good fidelity of the livery as printed on the manufactured object with respect to the livery as designed on the designed object, notably when the geometry of the manufactured object does not correspond perfectly to the designed object with errors which are significantly larger than the required printing precision;
to guarantee that certain vertices correspond precisely to certain points of the manufactured object; and
to guarantee that the (geometric) proportions of certain elements of the texture are maintained.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for determining a textured mesh referred to as a transformed textured mesh of a three-dimensional manufactured object based on a textured mesh, referred to as an initial textured mesh, of a three-dimensional designed object, the transformed textured mesh for printing a two-dimensional texture on the three-dimensional manufactured object, the three-dimensional manufactured object corresponding to the three-dimensional designed object, the method being implemented by a computer device and comprising the following steps:
a reception step for receiving a mesh representing the three-dimensional designed object and an associated two-dimensional texture, which form said initial textured mesh comprising vertices, as well as three-dimensional points from a cloud of points acquired on the three-dimensional manufactured object; and
a determination step for determining the transformed textured mesh, taking into account at least some of said vertices and at least some of said three-dimensional points,
wherein the determination step implements iterative processing in order to determine a set of affine transformations with individualized parameters to minimize a value of a target function, taking account of said initial textured mesh and of said three-dimensional points taken into account from the cloud of points, the target function comprising at least one term promoting a specific property relating to the set of affine transformations, the set of affine transformations thus determined being applied to the vertices taken into account of the initial textured mesh so as to obtain said transformed textured mesh.

2. The method of claim 1, wherein the determination step comprises the following successive substeps implemented iteratively:
a first substep for applying a set of affine transformations to the vertices taken into account of the initial textured mesh so as to obtain vertices of a textured mesh referred to as a computed textured mesh, said set of affine transformations corresponding, during a first iteration, to a predetermined set of affine transformations and, during each following iteration, to a set of affine transformations which is determined in a preceding iteration;
a second substep for computing the value of the target function based on the vertices taken into account of the initial textured mesh, of the three-dimensional points taken into account from the cloud of points and of the vertices of the computed textured mesh;
a third substep for comparing a computed value of the target function with a predetermined threshold value and for:
when said computed value is less than the threshold value, stopping the determination step and considering that the transformed textured mesh corresponds to the textured mesh computed in the first substep of a current iteration; and
when said computed value is greater than or equal to the threshold value, continuing the determination step by implementing a fourth substep; and
the fourth substep for determining a new set of affine transformations depending on the target function and on the set of affine transformations, the new set of affine transformations being used in the first substep of a following iteration.

3. The method of claim 1, wherein said determination step is stopped when a predetermined number of iterations is reached, the transformed textured mesh corresponding to a last computed textured mesh.

4. The method of claim 1, wherein the target function comprises at least one term causing certain vertices of the transformed textured mesh to correspond to points referred to as target points of the manufactured object.

5. The method of claim 1, wherein the target function comprises at least one term causing certain vertices of the transformed textured mesh to maintain a predetermined distance between them.

6. The method of claim 1, wherein the target function comprises:
a term causing the transformed textured mesh to adapt to the three-dimensional points acquired on the three-dimensional manufactured object; or
a term causing a transformation generated by the set of affine transformations to force a smooth distortion; or
a term causing a transformation generated by the set of affine transformations to approach a rigid transformation; or
any combination thereof.

7. The method of claim 2, wherein the fourth substep comprises:
computing a gradient of the target function with respect to the set of affine transformations;
determining a direction of adjustment based on the gradient; and
determining a new set of affine transformations along this direction of adjustment.

8. The method of claim 2, wherein the fourth substep uses a specialized non-linear least squares solver.

9. The method of claim 1, further comprising:
a computing step for determining an initial set of affine transformations; or
a computing step for determining target points of the three-dimensional manufactured object; or
a computing step for determining at least one zone of the two-dimensional texture a proportions of which are preserved; or
any combination thereof.

10. A computer device for determining a textured mesh referred to as a transformed textured mesh of a three-dimensional manufactured object based on a textured mesh, referred to as an initial textured mesh, of a three-dimensional designed object, the transformed textured mesh for printing a two-dimensional texture on the three-dimensional manufactured object, the three-dimensional manufactured object corresponding to the three-dimensional designed object, said computer device comprising:
a reception unit configured to receive a mesh representing the three-dimensional designed object and an associated two-dimensional texture, which form said initial textured mesh comprising vertices, as well as three-dimensional points from a cloud of points acquired on the three-dimensional manufactured object; and
a computing unit configured to determine the transformed textured mesh, taking into account at least some of said vertices and at least some of said three-dimensional points,
wherein the computing unit comprises computing elements configured to implement iterative processing in order to determine a set of affine transformations with individualized parameters to minimize a value of a target function, taking account of said initial textured mesh and of said three-dimensional points taken into account from the cloud of points, the target function comprising at least one term promoting a specific property relating to the set of affine transformations, the set of affine transformations thus determined being applied to the vertices taken into account of the initial textured mesh so as to obtain said transformed textured mesh.
